(19) United States
(12) Patent Application Publication
(10) Pub. No.: US 2026/0254163 A1
(43) Pub. Date: Aug. 27, 2026

(54) ELECTRICAL CONNECTOR

(71) Applicant: FCA US LLC, Auburn Hills, MI (US)

(72) Inventor: Mark E. Pollard, Auburn Hills, MI (US)

(21) Appl. No.: 19/061,513

(22) Filed: Feb. 24, 2025

(51) Int. Cl. H01R 13/629

(52) U.S. Cl. CPC H01R 13/629; H01R 2201/26

(57) ABSTRACT

The electrical connector may include a socket with a socket body, the socket body has a first end and an opposite second end, an intermediate wall extending between the first end and the second end, a slot between the first end and the second end, the slot having an inlet open through the intermediate wall, and the socket body has a receptacle that is open through an opening in the intermediate wall and defined at least in part by the intermediate wall. A plug may have a plug body with a guide extending from the plug body, where the guide is configured to be received in the slot and the plug body is configured to be received at least partly in the receptacle.

### FIELD

The present disclosure relates to an electrical connector for a vehicle.

### BACKGROUND

Electrical connections in vehicles can be unknowingly partially connected or become unconnected over time due to vibration or tension in the associated wiring. This results in loss of data and/or power to electrical components of the vehicle and can lead to the malfunction of electrical components of the vehicle.

### SUMMARY

In at least some implementations, an electrical connector includes a socket with a socket body. The socket body has a first end, an opposite second end, an intermediate wall extending between the first end and the second end, and a slot in the intermediate wall between the first end and the second end. The slot has an inlet through the intermediate wall, a first portion that extends part of the way through the socket body from the inlet to a first end wall, a second portion that is open to the first portion and that extends from the first portion to a second end wall, and the socket body has a receptacle that is open through an opening in the intermediate wall and defined at least in part by the intermediate wall. One or more socket conductors are arranged within the socket body. A plug has a plug body with a guide extending from the plug body and one or more plug conductors, wherein the guide is configured to be received in the slot and the plug body is configured to be received at least partly in the receptacle when the guide is received in the second portion of the slot, and wherein movement of the plug to a connected state wherein the one or more plug conductors are in contact with the one or more socket conductors is prevented when the guide is within the first portion of the slot and is permitted when the guide is within the second portion of the slot.

In at least some implementations, the opening extends through the intermediate wall and at least part of the first end of the socket body, and the slot is open to the opening.

In at least some implementations, the slot extends through an inner surface of the intermediate wall and an outer surface of the intermediate wall and is open to the receptacle.

In at least some implementations, the socket conductors are arranged in a bottom wall of the socket body that defines part of the receptacle, and the first portion of the slot includes a portion that is angled away from the bottom wall to a peak and the first portion of the slot includes another portion that is angled towards the bottom wall.

In at least some implementations, the socket conductors are positioned on or in a bottom wall within the receptacle.

In at least some implementations, the second portion of the slot extends in a direction that extends between the first end of the socket body and the second end of the socket body.

In at least some implementations, the second portion of the slot is further defined by a third end wall that is opposite to the first end wall.

In at least some implementations, the plug has a plug alignment feature on the plug body that is configured to align with and abut a socket alignment feature on the socket body when the electrical connector is in the connected state.

In at least some implementations, a lip is positioned near the opening or the inlet of the socket body and is configured to align the plug body with the opening and the guide with the inlet.

In at least some implementations, in the connected state, the first end of the plug abuts a bottom wall of the socket.

In at least some implementations, an electrical connector includes a socket with a socket body. The socket body has a first end, an opposite second end, an intermediate wall extending between the first end and the second end, and a slot in the intermediate wall between the first end and the second end in more than one portion of the intermediate wall. The slot has an inlet through the intermediate wall, a first portion that extends part of the way through the socket body from the inlet to a first end wall, a second portion that is open to the first portion and that extends from the first portion to a second end wall, and the socket body has a receptacle that is open through an opening in the intermediate wall and defined at least in part by the intermediate wall. One or more socket conductors are arranged within the socket body. A plug having a plug body with a guide extends from the plug body in two, opposite directions and one or more plug conductors, wherein the guide is configured to be received in the slot and the plug body is configured to be received at least partly in the receptacle when the guide is received in the second portion of the slot, and wherein movement of the plug to a connected state wherein the one or more plug conductors are in contact with the one or more socket conductors is prevented when the guide is within the first portion of the slot and is permitted when the guide is within the second portion of the slot.

In at least some implementations, the opening extends through the intermediate wall and at least part of the first end of the socket body, and the slot is open to the opening.

In at least some implementations, the slot extends through an inner surface of the intermediate wall and an outer surface of the intermediate wall in two portions of the intermediate wall, and is open to the receptacle. the socket conductors are arranged in a bottom wall of the socket body that defines part of the receptacle, and the first portion of the slot includes a portion that is angled away from the bottom wall to a peak and the first portion of the slot includes another portion that is angled towards the bottom wall.

In at least some implementations, the socket conductors are positioned on or in a bottom wall within the receptacle.

In at least some implementations, the second portion of the slot extends in a direction that extends between the first end of the socket body and the second end of the socket body.

In at least some implementations, the second portion of the slot is further defined by a third end wall that is opposite to the first end wall.

In at least some implementations, the plug has a plug alignment feature on the plug body that is configured to align with and abut a socket alignment feature on the socket body when the electrical connector is in the connected state.

In at least some implementations, a lip is positioned near the opening or the inlet of the socket body and is configured to align the plug body with the opening and the guide with the inlet.

In at least some implementations, in the connected state, the first end of the plug abuts a bottom wall of the socket.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a side view of an electrical connector;

FIG. 2 is a perspective view of a socket of the electrical connector;

FIG. 3 is a view from a first end of the socket;

FIG. 4 is a cross-sectional view along section line A-A of FIG. 3;

FIG. 5 is a perspective view of a plug;

FIG. 6 is another perspective view of the plug of FIG. 7;

FIG. 7 is a view of the plug from a first end;

FIG. 8 is a cross-sectional view along section line B-B of FIG. 7;

FIG. 9 is a top view of a second end of the plug and the first end of the socket when the electrical connector is in a connected state;

FIG. 10 is a perspective view of the electrical connector in a unconnected state;

FIG. 11 is a perspective view of the electrical connector between the unconnected state and the connected state;

FIG. 12 is another perspective view of the electrical connector between the unconnected state and the connected state; and

FIG. 13 is cross-sectional view of the electrical connector along sectional line C-C of FIG. 9.

### DETAILED DESCRIPTION

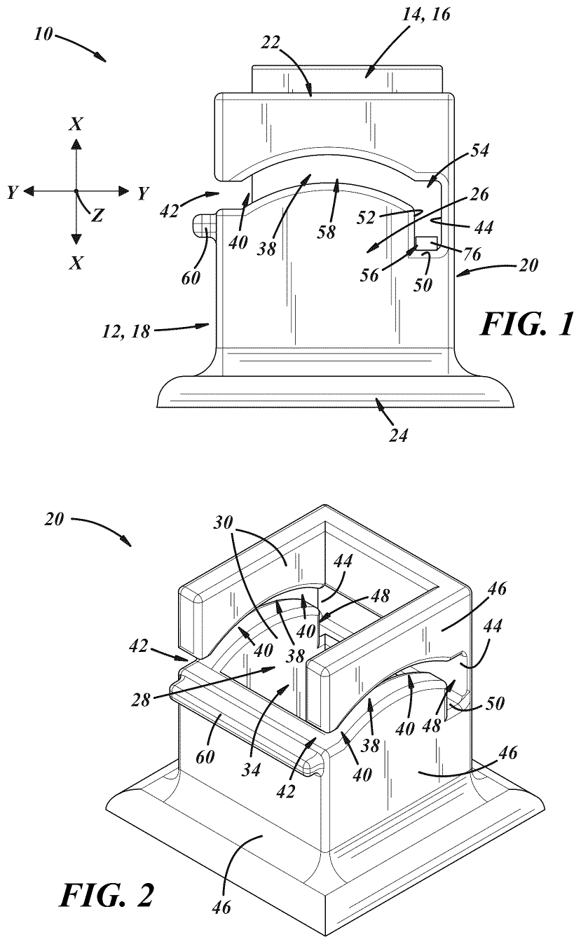

Referring in more detail to the drawings, FIG. 1 illustrates an electrical connector 10 having a first part 12 and a second part 14. The parts of the electrical connector may include mating engagement features, which may include male and female structures, like a plug 16 and socket 18, and associated conductive contacts that are electrically coupled together when the two parts are connected. To facilitate description of the connector parts, the first part 12, which is shown as having a female portion will be called a socket 18, and the second part 14, which is shown as having a male portion will be called a plug 16. An electrical connection may be established between the plug 16 and socket 18 of the electrical connector 10 when the two parts 12, 14 are coupled together. The plug 16 and socket 18 may be coupled to separate components, like cables or other parts of a circuit (e.g. a circuit board) to electrically connect the components through the connector 10, such as to complete the electrical circuit when the connector 10 is in a connected state, as shown in FIG. 1.

As shown in FIGS. 1 and 2, the socket has a socket body 20 with a first end 22 and an opposite, second end 24 spaced apart in a first direction or dimension that will be called a length herein, and is shown by arrow X in FIG. 1. The first end 22 and second end 24 both have a width and depth, which are dimensions perpendicular to each other and to the length, and which are shown by arrows Y and Z in FIG. 1. An intermediate wall 26 extends lengthwise between the first end 22 and the second end 24, and may have any peripheral or cross-sectional shape.

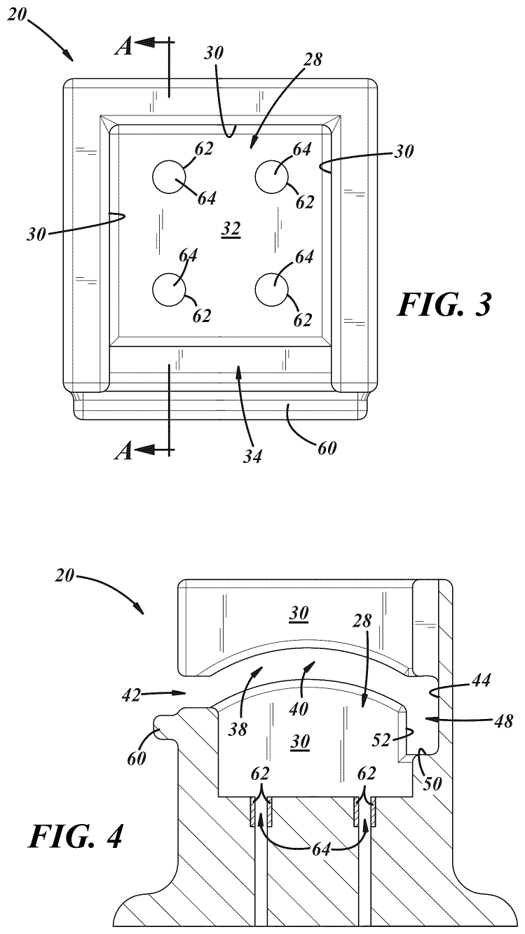

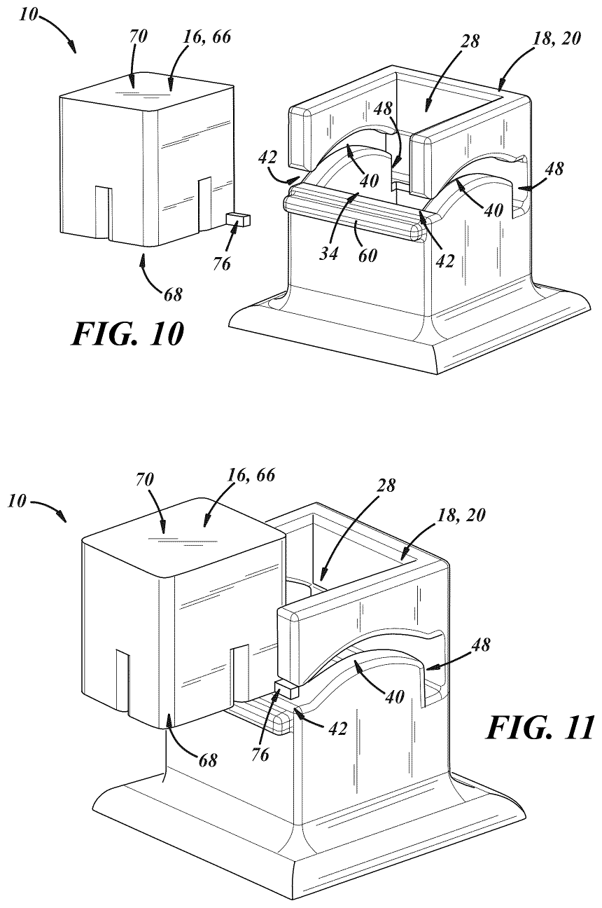

In the example shown, the socket body 20 is generally cubic and the intermediate wall 26 has four flat faces that, with the first end 22 and the second end 24, define the exterior of the socket body 20. A receptacle 28 is defined by an inner surface 30 of part of the intermediate wall 26 from the first end 22 and extending lengthwise to a bottom wall 32, shown in FIG. 3, that is spaced in direction X from the second end 24 of the socket body 20. In at least some implementations, an opening 34 to the receptacle 28 is formed through part of the intermediate wall 26 from the first end 22 toward the second end 24. The opening 34 may have the same widthwise dimension as the receptacle 28, and is defined in part by inner surfaces 30 of widthwise opposite portions of the intermediate wall 26. In some implementations, as shown in FIGS. 1-4 and 9-13, the opening 34 continues through at least part of the first end 22 of the socket body 20. In other implementations, depending on the desired dimensions of the socket 18 and the plug 16, the opening may extend through a portion of the first end (as shown in FIG. 2), extend through more or less of a portion of the first end than as shown in FIG. 2, or the opening 34 may not extend through the first end 22 at all. In at least some implementations, the inner surface 30 of the intermediate wall 26 may have one or more socket alignment features 36 to align the plug 16 within the receptacle 28. The socket alignment feature(s) 36 may be, by way of non-limiting examples, grooves in the inner surface 30 of the intermediate wall 26 or ridges extending from the inner surface 30 of the intermediate wall 26 along the inner surface 30 between the first end 22 of the socket body 20 and the bottom wall 32.

A slot 38 is provided in part of the intermediate wall 26, between the first end 22 and the bottom wall 26 of the receptacle 28 of the socket body 20 so that the slot 38 is open to the receptacle 28. The slot 38 has a first portion 40 that extends depthwise into the socket body 20 from an inlet 42 to a first end wall 44 located part of the way through the socket body 20, and on an opposite side of the receptacle 28 as the inlet 42. Thus, in at least some implementations, the first portion 40 of the slot 38 extends across the receptacle 28 from one side to the opposite side of the receptacle 28 (e.g. from a front side to a rear side). The inlet 42 extends through an outer surface 46 of the intermediate wall 26 between the first end 22 and the second end 24, is open to or contiguous with the opening 34 in the intermediate wall 26, and is located between the opening 34 and the second end 24 of the socket body 20. The inlet 42 leads to the first portion 40 of the slot 38 to enable an object to be inserted into the slot 38 from outside of the socket body 20.

The slot 38 also includes a second portion 48 that extends from, is continuous with, and is open to the first portion 40 of the slot 38. The second portion 50 extends lengthwise in the socket body 20 and is defined by a first end wall 44, a second end wall 50 that may be perpendicular to the first end wall 44, and a third end wall 52 perpendicular to the second end wall 50 and opposite to the first end wall 44. The first end wall 44 may be a portion of the intermediate wall 26 between the inner 30 and outer surface 46 of the intermediate wall 26 and may extend lengthwise and widthwise. The second portion 48 of the slot 38 extends from a first end 54 to a second end 56 that is closer to the second end 24 of the socket body 20 than the first end 54, and the second end 56 of the second portion 48 of the slot 38 is closer to the second end 24 of the socket body 20 than the first portion 40 of the slot 38.

The slot 38 may extend in more than one portion of the intermediate wall 26. For example, as shown in FIG. 2, the slot 38 extends in two portions of the intermediate wall 26 that are, separated by the receptacle 28 (e.g. the slots are on opposite sides of the receptacle 28, and extend from the front side toward the rear side). As shown in FIG. 2, the slot 38 may extend widthwise through both the inner surface 30 and the outer surface 46 of the intermediate wall 26. In other implementations, the slot 38 may extend through the inner surface 30 of the intermediate wall 26 (so that the slot 38 is open to and contiguous with the receptacle 28), but not through the outer surface 46 (e.g. defining one or more channels in the intermediate wall 26). As shown in FIG. 2, at least part of the first portion 40 of the slot 38 may have non-zero slope, with lengthwise changes in the slope and relative to the first end 22 and the second end 24. For example, in moving from the inlet 42 toward the first end wall 44, the first portion 40 of the slot 38 may be angled or inclined away from the bottom wall 32 of the receptacle 28 until a peak 58. At the peak 58, the first portion 40 may be angled or inclined towards the bottom wall 32 of the receptacle 28 until the first portion 40 meets the second portion 48 of the slot 38. Of course, other slot shapes may be used, as desired.

In some implementations, as shown in FIG. 2, the intermediate wall 26 may include a lip 60 that extends outwardly from the adjacent portion of the outer surface 46, and the lip 60 may be positioned at or near the opening 34 and/or the inlet 42 of the slot. In the example shown in FIG. 2, the lip 60 is between the inlet 42 and the second end 24 of the socket body 20 and is gradually sloped towards the inlet 42 to assist in alignment of the plug 16 with the socket 18 as will be described in more detail later. Other positions, sizes, and orientations of the lip 60, may be used.

One or more socket conductors 62 may be arranged on the bottom wall 32 within the receptacle 28. The socket conductors 62 are capable of conducting electricity to other electrical components such as wires, circuit boards, or contacts that may be positioned beyond the bottom wall 32 or beyond the socket body 20. In at least some implementations, as shown by FIGS. 3 and 4, the socket conductors 62 may be in a female configuration that extend into the bottom wall 32 and are exposed in the receptacle 28. In other implementations, as shown by FIGS. 4 and 6, the socket conductors 62 may be in a male configuration that extend from the bottom wall 32 into the receptacle 28, and in other implementations, the socket conductors 62 may include a mix of male and female conductors. A non-limiting example shown by FIGS. 3-4 includes four socket conductors 62 that are cylindrical in shape and are equally spaced from each other within cavities 64 formed in the bottom wall 32. The cavities 64 include passages through which, for example, wires connected to the conductors 62 may be received. The quantity, shape, size, and location of the conductors 62 may be altered, as desired. For example, more or fewer conductors 62 may be desired or conductors 26 of varying size may be desired depending on one or more factors such as the power of electricity to be conducted through the socket conductors 62, the quantity and type of data to be transmitted through the socket conductors 62, among others.

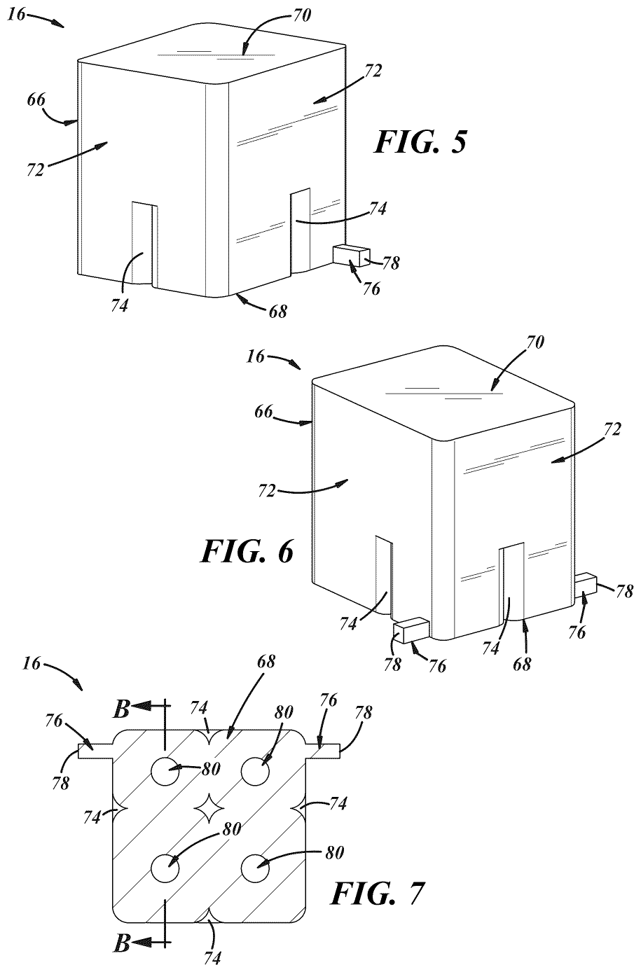

As shown by FIGS. 5-8, the plug 16 has a plug body 66 that has a first end 68 and a second end 70, and an intermediate wall 72 extending between the first and second ends 68, 70 of the plug body 66. In some implementations, as shown by FIGS. 5-6, the plug body 66 may have one or more plug alignment feature(s) 74. The plug alignment feature(s) 74 may be grooves provided in the plug body 66 or ridges extending from the plug body 66 that may be configured to interact with and be complementary with the alignment features 36 of the socket 18. FIGS. 5-6 show an example of the plug 16 with grooves in the plug body 66 as alignment features 74. The first end 68 of the plug body 66 and at least part of the length of the intermediate wall 26 is configured to fit within the receptacle 28 to enable connection of the plug 16 and socket 18. The exterior of at least part of the intermediate wall 72 may be complementary in shape to the inner surface 30 of the receptacle 28, and a relative tight fit may be provided, if desired, to inhibit unintentional disconnection of the plug body 66 from the socket body 20. Thus, in the example shown, the intermediate wall 72 of the plug body 66 includes multiple, flat faces and the plug body 66 is generally cubical, at least the part that in connection is received in the receptacle 28, which is also defined in part by four, flat surfaces, in this example. Of course, other shapes may be used for the plug body 66 and the receptacle 28 so long as suitable connection can be achieved.

The plug body 66 also has a guide 76 that is cantilevered to and extends outwardly from the exterior of the plug body 66 to an outer end 78 of the guide 76. The plug body 66 and the guide 76 have a greater width than the width of the receptacle 28. The guide 76 may have any desired depth, and a length smaller than the length dimension of the slot 38 so that the guide 76 can be received in the slot 38 through the inlet 42. The guide 76 may be configured to extend beyond the plug body 66 in one or more directions, as shown by FIGS. 5-6 where the guide 76 from opposite sides of the plug body 66 in two, opposite directions. A portion of the guide 76 may be coplanar with the first end 68 of the plug 16, although the guide 76 can be moved lengthwise toward the second end 70 of the plug body 66 so long as the socket body 20 is designed to accommodate the guide 76.

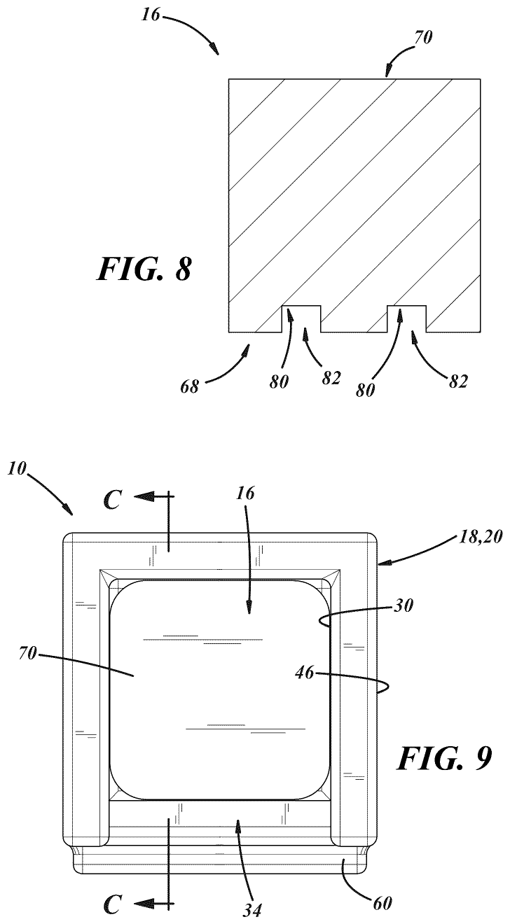

As shown by FIGS. 7-8, plug conductors 80 may be positioned at or accessible from the first end 68 of the plug body 66. The plug conductors 80 are complementary to the socket conductors 62 and may include female, male or a mix of male and female conductors suitable to enable electrical connection with the socket conductors 62. Any arrangement, size and shape of the conductors 80 may be used, to achieve a desired connection. In FIGS. 7-8, the plug conductors 80 are female conductors that are received in cavities 82 formed in the first end 68 of the plug body 66 and may be configured to receive male socket conductors 62.

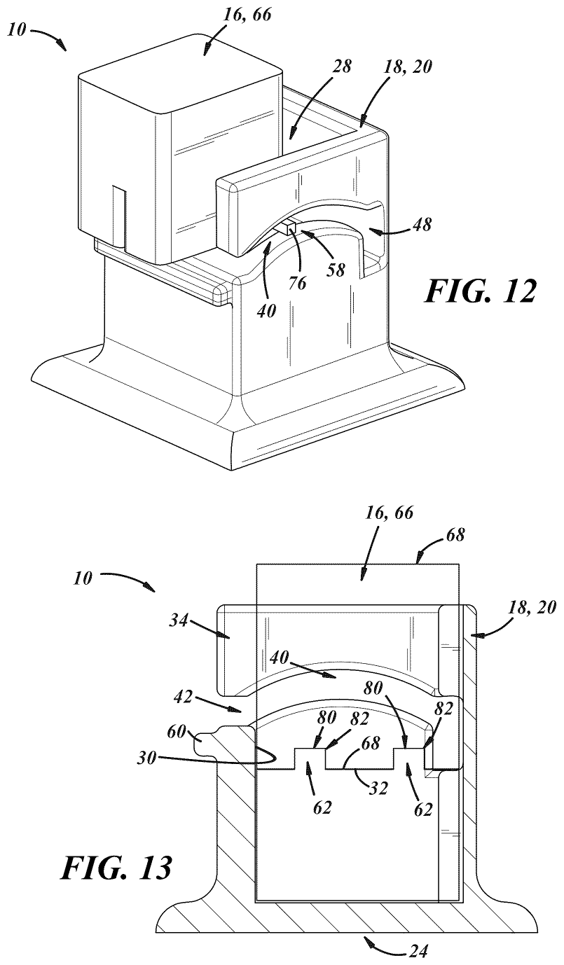

The electrical connector 10 has two states, a connected state, as shown by FIGS. 1, 9, and 13, and a disconnected state, as shown by FIG. 10. In the connected state, the plug conductors 80 and the socket conductors 62 are in electrical communication with each other. To move from the disconnected state to the connected state, as shown by FIG. 11, the plug body 66 is aligned with the opening 34 of the socket body 20, and the guide 76 as shown by FIG. 11, is aligned with the inlet 42 of the slot 38. The plug body 66 may be inserted in the opening 34 with the guide 76 slidably received in the first portion 40 of the slot 38, as shown in FIG. 12. When the plug body 66 is fully advanced depth-wise into the receptacle 28, the guide 76 is at or adjacent to the first end wall 44 of the slot 38 and is aligned with the second portion 48 of the slot 38. The plug body 66 may also engage the inner surface 30 of the intermediate wall 26 adjacent to the first end wall 44. In this position, any plug alignment features 74 may be aligned with any socket alignment features 36 so that movement of the plug body 66 toward the second end 24 of the socket body 20 is guided by the alignment features, 36, 74 and also by the guide 76 which moves within the second portion 48 of the slot 38.

With the guide 76 aligned with the second portion 48 of the slot 38, the plug 16 can be moved towards the bottom wall 32 of the socket body 20 which moves the guide 76 towards the second end wall 50 at the end of the second portion 48 of the slot 38. The plug 16 is moved until the plug conductors 80 are in electrical communication with the socket conductors 62, and in at least some implementations, the guide 76 may abut the second end wall 50 of the second portion 48 of the slot 38 in the fully connected state. This may provide a visual indication that the connector 10 is in the connected state, at least when the second portion 48 of the slot 38 is open to the outer surface 46 of the intermediate wall 26 such that the guide 76 can be viewed from the exterior of the connector 10. In the connected state, as shown in FIGS. 1, 9, and 13, when the plug conductors 80 are in the female configuration and the socket conductors 62 are in the male configuration, the first end 68 of the plug body 66 abuts the bottom wall 32 so that the socket conductors 62 are received within the plug conductors 80 to provide an electrical connection between the plug conductors 80 and the socket conductors 62.

The plug 16 may be removed from the socket 18 by force applied on the plug body 66 in an opposite direction to move the first end 68 of the plug 16 away from the bottom wall 32 of the socket 18, and the guide 76 away from the second end wall 50 and toward the first portion 40 of the slot 38. When the guide 76 is aligned with the first portion 40 of the slot 38, the conductors 62, 80 are fully disconnected and the plug 16 may then be moved out of the receptacle 28 through the opening 34 with the guide 76 sliding through the first portion 40 of the slot 38 towards and through the inlet 42. As shown by FIG. 10, the electrical connector 10 is in the fully disconnected state when the guide 76 leaves the first portion 40 of the slot 38 through the inlet 42 and the plug body 66 leaves the receptacle 28 through the opening 34.

Electrical connections may use push to connect systems where the conductors are pushed together through friction fit interaction of electrically conductive components or lever-activated latches where a lever uses leverage to create or maintain electrical communication between two electrically conductive components. However, in both push to connect systems and lever-activated latch systems the electrical connection may unknowingly be partially connected or unconnected. This results in loss of data or power to electrical components of the vehicle in addition to potential damage to the connector and electrical components of the vehicle through lack of an expected electric current or signal or transmission of an unexpected electric current or signal.

The electrical connector 10 disclosed herein is designed to prevent accidental disconnection or incomplete connection of the plug conductors 80 with the socket conductors 62. The first portion 40 of the slot 38 of the socket body 20 and the guide 76 of the plug body 66 are arranged so that the surface of the first portion 40 of the slot 38 that is closest to the bottom wall 32 of the receptacle 28 is spaced from the bottom wall 32 at least far enough that the conductors 62, 80 of the socket 18 and plug 16 cannot contact each other when the guide 76 is within the first portion 40 of the slot 38. Therefore, the plug body 66 cannot be advanced toward the bottom wall 32 of the socket 18 until the guide 76 is fully moved through the first portion 40 of the slot 38 and is aligned with the second portion 48 of the slot 38. This ensures that the plug body 66 must be fully advanced (in the depth-wise direction) until the first end 68 of the plug body 66 is fully received in and aligned with the receptacle 28 before the plug 16 can be moved to the connected state. And in this state, all conductors 62, 80 of the plug 16 and socket 18 are aligned such that attempts to connect the plug 16 and socket 18 with less than full alignment are prevented.

Further, the second portion 48 of the slot 38 extends in the direction of connection, and helps to prevent the plug body 66 from being moved out of alignment (e.g. slid or tilted in the depth-wise direction and out of alignment). The complementary intermediate walls 26, 72 of the plug body 66 and socket body 20, as well as any alignment features 36, 74 provided, may also ensure the that plug body 66 remains fully overlapped and aligned with the receptacle 28 when the plug body 66 is advanced toward the bottom wall 32.

The electrical connector 10 can also provide visual confirmation and tactile confirmation that the connected position has been achieved. For example, a user of the electrical connector 10 may visually recognize that the connector 10 has reached the connected position when the guide 76 is abutted to the second end wall 50 within the second portion 48 of the slot 38 (in implementations where the slot 38 extends through the outer surface 46 of the intermediate wall 26), or when the plug body 66 is seated within the receptacle 28. Tactile confirmation may be provided by feeling a change of direction of the plug 16 as the guide 76 enters the second portion 48 of the slot 38 from the first portion 40 resulting in a change of direction of the plug 16. In the implementation shown by FIGS. 1 and 11-13, the guide 76 will not advance to the second portion 48 of the slot 38 without passing the inclined portion and peak 58 of the first portion 40 of the slot 38, which can be felt by an installer. Further, movement of the guide 76 through the inclined portion moves the plug body 66 further away from the bottom wall 32 of the receptacle 28 and ensures the conductors 62, 80 cannot come into contact with each other prematurely. Therefore, without the guide 76 entering the second portion 48 of the slot 38, the user will be visually and tactilely aware that the electrical connector 10 is not in the connected state. Furthermore, when the plug conductors 80 and socket conductors 62 are fully connected, the abutment of the bottom wall 32 of the socket 18 with the first end 68 of the plug body 66 or the abutment of the guide 76 with the second end wall 50 will prevent further movement of the plug body 66, tactilely confirming to the user that the connected position has been reached.

What is claimed is:

1. An electrical connector comprising:
a socket with a socket body, the socket body has a first end, an opposite second end, an intermediate wall extending between the first end and the second end, and a slot in the intermediate wall between the first end and the second end, the slot having an inlet through the intermediate wall, the slot has a first portion that extends part of the way through the socket body from the inlet to a first end wall, the slot has a second portion that is open to the first portion and that extends from the first portion to a second end wall, and the socket body has a receptacle that is open through an opening in the intermediate wall and defined at least in part by the intermediate wall;
one or more socket conductors arranged within the socket body; and
a plug having a plug body with a guide extending from the plug body and one or more plug conductors, wherein the guide is configured to be received in the slot and the plug body is configured to be received at least partly in the receptacle when the guide is received in the second portion of the slot, and wherein movement of the plug to a connected state wherein the one or more plug conductors are in contact with the one or more socket conductors is prevented when the guide is within the first portion of the slot and is permitted when the guide is within the second portion of the slot.

2. The electrical connector of claim 1, wherein the opening extends through the intermediate wall and at least part of the first end of the socket body, and the slot is open to the opening.

3. The electrical connector of claim 1, wherein the slot extends through an inner surface of the intermediate wall and an outer surface of the intermediate wall and is open to the receptacle.

4. The electrical connector of claim 1, wherein the socket conductors are arranged in a bottom wall of the socket body that defines part of the receptacle, and the first portion of the slot includes a portion that is angled away from the bottom wall to a peak and the first portion of the slot includes another portion that is angled towards the bottom wall.

5. The electrical connector of claim 1, wherein the socket conductors are positioned on or in a bottom wall within the receptacle.

6. The electrical connector of claim 1, wherein the second portion of the slot extends in a direction that extends between the first end of the socket body and the second end of the socket body.

7. The electrical connector of claim 1, wherein the second portion of the slot is further defined by a third end wall that is opposite to the first end wall.

8. The electrical connector of claim 1, wherein the plug has a plug alignment feature on the plug body that is configured to align with and abut a socket alignment feature on the socket body when the electrical connector is in the connected state.

9. The electrical connector of claim 1, wherein a lip is positioned near the opening or the inlet of the socket body and is configured to align the plug body with the opening and the guide with the inlet.

10. The electrical connector of claim 1, wherein in the connected state, the first end of the plug abuts a bottom wall of the socket.

11. An electrical connector comprising:
a socket with a socket body, the socket body has a first end, an opposite second end, an intermediate wall extending between the first end and the second end, and a slot in the intermediate wall between the first end and the second end in more than one portion of the intermediate wall, the slot having an inlet through the intermediate wall, the slot has a first portion that extends part of the way through the socket body from the inlet to a first end wall, the slot has a second portion that is open to the first portion and that extends from the first portion to a second end wall, and the socket body has a receptacle that is open through an opening in the intermediate wall and defined at least in part by the intermediate wall;
one or more socket conductors arranged within the socket body; and
a plug having a plug body with a guide extending from the plug body in two, opposite directions and one or more plug conductors, wherein the guide is configured to be received in the slot and the plug body is configured to be received at least partly in the receptacle when the guide is received in the second portion of the slot, and wherein movement of the plug to a connected state wherein the one or more plug conductors are in contact with the one or more socket conductors is prevented when the guide is within the first portion of the slot and is permitted when the guide is within the second portion of the slot.

12. The electrical connector of claim 11, wherein the opening extends through the intermediate wall and at least part of the first end of the socket body, and the slot is open to the opening.

13. The electrical connector of claim 11, wherein the slot extends through an inner surface of the intermediate wall and an outer surface of the intermediate wall in two portions of the intermediate wall, and is open to the receptacle.

14. The electrical connector of claim 11, wherein the socket conductors are arranged in a bottom wall of the socket body that defines part of the receptacle, and the first portion of the slot includes a portion that is angled away from the bottom wall to a peak and the first portion of the slot includes another portion that is angled towards the bottom wall.

15. The electrical connector of claim 11, wherein the socket conductors are positioned on or in a bottom wall within the receptacle.

16. The electrical connector of claim 11, wherein the second portion of the slot extends in a direction that extends between the first end of the socket body and the second end of the socket body.

17. The electrical connector of claim 1, wherein the second portion of the slot is further defined by a third end wall that is opposite to the first end wall.

18. The electrical connector of claim 11, wherein the plug has a plug alignment feature on the plug body that is configured to align with and abut a socket alignment feature on the socket body when the electrical connector is in the connected state.

19. The electrical connector of claim 11, wherein a lip is positioned near the opening or the inlet of the socket body and is configured to align the plug body with the opening and the guide with the inlet.

20. The electrical connector of claim 11, wherein in the connected state, the first end of the plug abuts a bottom wall of the socket.
